(19) United States
(12) Patent Application Publication
(10) Pub. No.: US 2009/0105415 A1
(43) Pub. Date: Apr. 23, 2009

(54) AMPHIPHILIC POLYMER AND METHOD FOR PREPARING THE SAME

(76) Inventors: Chia-Chang LIU, Taipei City (TW); Ken-Yuan Chang, Taoyuan Hsien (TW); Fa-Chen Chi, Taoyuan Hsien (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/192,575

(22) Filed: Aug. 15, 2008

(30) Foreign Application Priority Data
Oct. 18, 2007 (TW) 096139010

(51) Int. Cl. C08G 63/91

(52) U.S. Cl. 525/54.2; 525/435

(57) ABSTRACT

An amphiphilic polymer having the following formula (I):

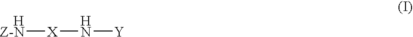

wherein Z is a hydroxyl-substituted aliphatic group derived from a sugar moiety and having formula (Z1) or (Z2):

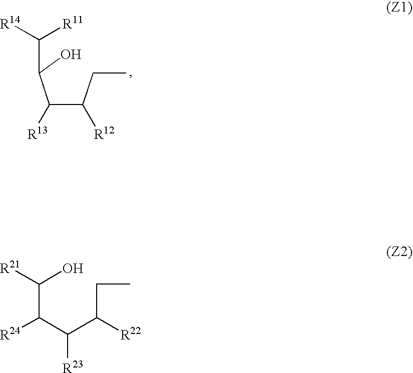

wherein R¹¹ and R²¹ are independently hydrogen, hydroxyl, hydroxymethyl, methyl, or a C₁-C₂₀ alkyl group; R¹², R¹³, R¹⁴, R²², R²³, and R²⁴ are independently hydrogen, hydroxyl, or a sugar moiety;
X is a C₁-C₆ divalent aliphatic group; and
Y is a biodegradable polyester block having a repeating unit represented by the following formula (II):

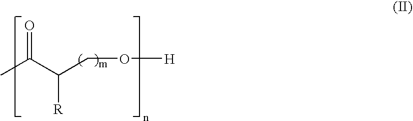

wherein, in each repeating unit, R is hydrogen or a C₁-C₁₈ alkyl group, m is an integer ranging from 0 to 5, and n is an integer ranging from 10 to 300. A method for preparing the amphiphilic polymer is also disclosed.

### CROSS-REFERENCE TO RELATED APPLICATION

This application claims priority of Taiwanese application no. 96139010, filed on Oct. 18, 2007.

### BACKGROUND OF THE INVENTION

1. Field of the Invention

This invention relates to an amphiphilic polymer, more particularly to an amphiphilic polymer, which can be used as a transdermal delivery carrier.

2. Description of the Related Art

An amphiphilic polymer is a polymer including hydrophilic and hydrophobic groups, and has been widely used in the pharmaceutical field, cosmetics field, etc.

Tatsuro Ouchi et al. discloses a method for preparing an amphiphilic polymer (Biomacromolecules 2003, 4, 477-480). Specifically, as shown in scheme 1, 2-aminoethanol was reacted with (Boc)₂O so as to form Boc-aminoethanol, in which a reactive amino end group of 2-aminoethanol was protected by a Boc group (protection step), followed by polymerization of Boc-aminoethanol with L-lactide so as to form polyLA-NHBoc. Then, the Boc group was removed from polyLA-NHBoc so as to form polyLA-NH₂ (deprotection step). As shown in scheme 2, polyLA-NH₂ thus obtained in scheme 1 was reacted with lactose (method 1) or lactonolactone (method 2) so as to form Lac-polyLA. In the process according to this literature, since protection and deprotection of the reactive amino end group of 2-aminoethanol are required, the method is complicated, thereby resulting in increased preparation costs.

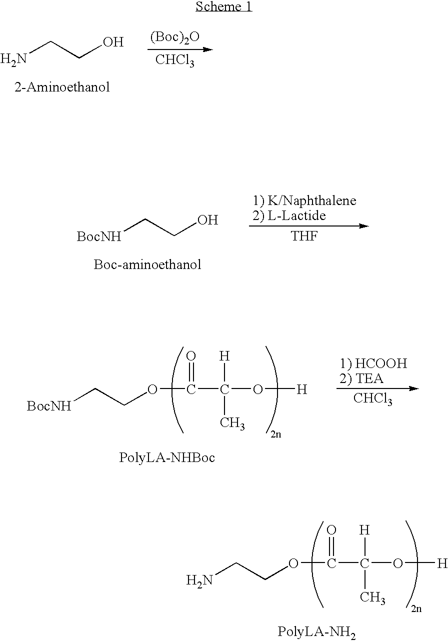

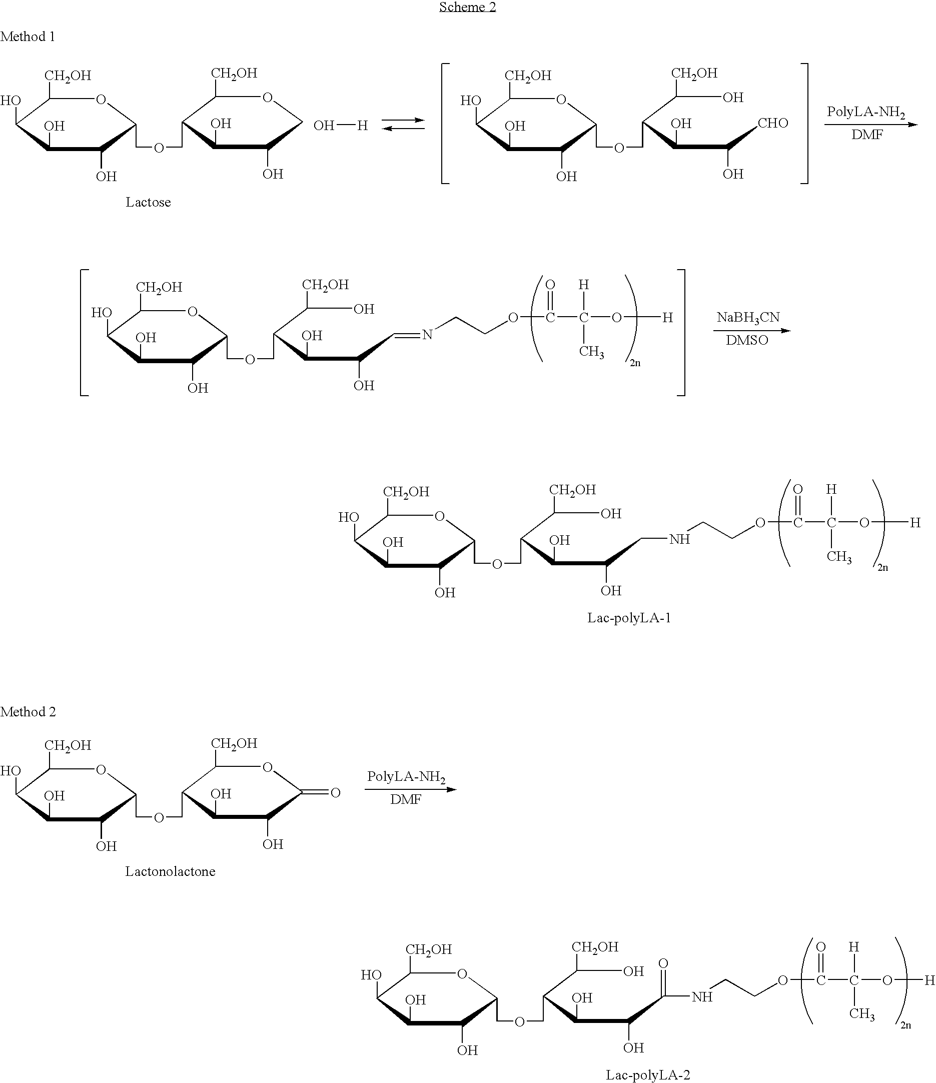

### SUMMARY OF THE INVENTION

Therefore, there is a need in the art to provide an amphiphilic polymer and a method for preparing the amphiphilic polymer, that can overcome the drawbacks of the aforesaid prior art.

According to one aspect of this invention, an amphiphilic polymer has the following formula (I):

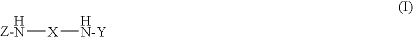

wherein Z is a hydroxyl-substituted aliphatic group having formula (Z1) or (Z2):

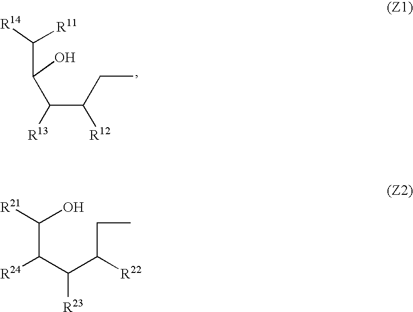

wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;

X is a C₁-C₆ divalent aliphatic group; and

Y is a biodegradable polyester block having a repeating unit represented by the following formula (II):

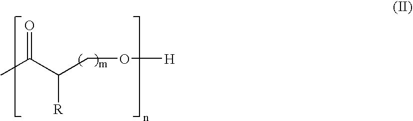

wherein, in each repeating unit, R is hydrogen or a C₁-C₁₈ alkyl group, m is an integer ranging from 0 to 5, and n is an integer ranging from 10 to 300.

According to another aspect of this invention, a method for preparing the aforesaid amphiphilic polymer includes the following step:

(a) reacting a diamine compound of formula (V):

H₂N—X—NH₂ (V)

with a sugar having formula (III) or (IV):

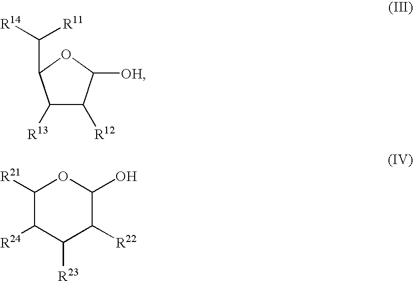

so as to form a compound having formula (VI):

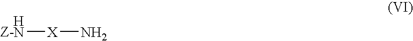

wherein Z is a hydroxyl-substituted aliphatic group having formula (Z1) or (Z2):

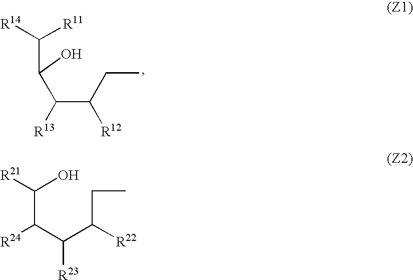

wherein R¹¹ of formulae (III) and (Z1) and R²¹ of formulae (IV) and (Z2) are independently hydrogen, hydroxyl, hydroxymethyl, methyl, or a C₁-C₂₀ alkyl group, and R¹², R¹³, R¹⁴ of formulae (III) and (Z1) and R²², R²³, and R²⁴ of formulae (IV) and (Z2) are independently hydrogen, hydroxyl, or a sugar moiety; and

(b) reacting a biodegradable polyester block of formula (VII):

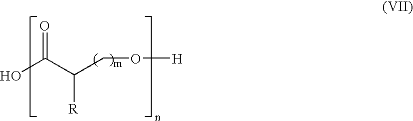

with the compound having formula (VI) so as to form the amphiphilic polymer,

wherein R is hydrogen or a C₁-C₁₈ alkyl group, m is an integer ranging from 0 to 5, and n is an integer ranging from 10 to 300.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a plot showing an FT-IR spectrum of the amphiphilic polymer of Example 1 of this invention; and

FIG. 2 shows a TEM image to illustrate the micelles composed of the amphiphilic polymer of Example 1 of this invention.

### DETAILED DESCRIPTION OF THE PREFERRED EMBODIMENTS

An amphiphilic polymer according to the present invention is shown to include a structure of formula (I):

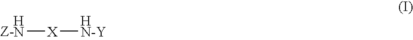

wherein Z is a hydroxyl-substituted aliphatic group having formula (Z1) or (Z2):

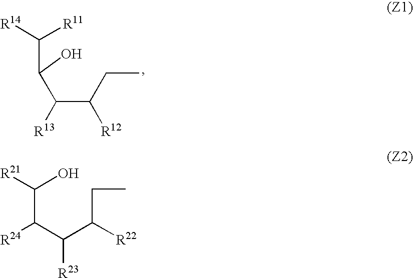

wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;

X is a C₁-C₆ divalent aliphatic group; and

Y is a biodegradable polyester block having a repeating unit represented by the following formula (II):

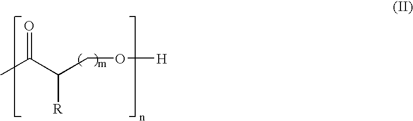

wherein, in each repeating unit, R is hydrogen or a C₁-C₁₈ alkyl group, m is an integer ranging from 0 to 5, and n is an integer ranging from 10 to 300.

Preferably, R¹², R¹³, R¹⁴, R²², R²³, and R²⁴ are independently hydrogen, and R¹¹ and R²¹ are independently hydroxymethyl, hydrogen, or a methyl group.

In one embodiment of this invention, Z is a hydroxyl-substituted aliphatic group having the formula (Z2). In formula (Z2), R²¹ is a hydroxymethyl group; R²² and R²³ are independently a hydroxyl group; and R²⁴ is

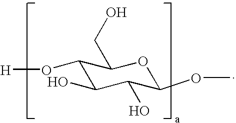

Preferably, a of R²⁴ is an integer ranging from 1 to 9, and is more preferably 1.

In another embodiment of this invention, Z is a hydroxyl-substituted aliphatic group having the formula (Z2). In formula (Z2), R²¹ is

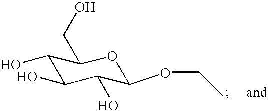

R²², R²³, and R²⁴ are independently a hydroxyl group.

In formula (I), preferably, X is a C₁-C₆ alkylene group. More preferably, X is an ethylene group.

Preferably, in formula (II), R is a methyl group or a hydrogen group, m is an integer ranging from 0 to 4, and n is an integer ranging from 10 to 200.

A method for preparing the aforesaid amphiphilic polymer includes the following step:

(a) reacting a diamine compound of formula (V)

H₂N—X—NH₂ (V)

with a sugar having formula (III) or (IV):

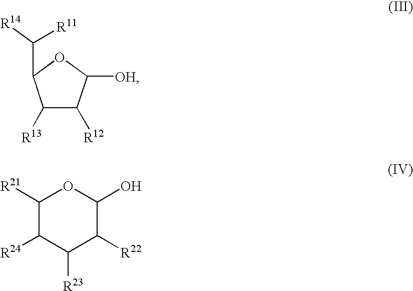

so as to form a compound having formula (VI):

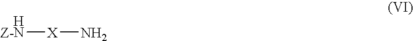

wherein Z is a hydroxyl-substituted aliphatic group having formula (Z1) or (Z2):

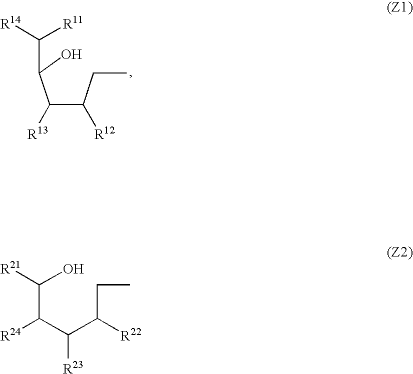

wherein R¹¹, R¹², R¹³, R¹⁴ of formulae (III) and (Z1), and R²¹, R²², R²³, and R²⁴ of formulae (IV) and (Z2) are as defined above;

(b) reacting a biodegradable polyester block of formula (VII):

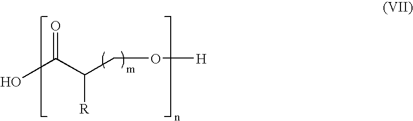

with the compound having formula (VI) so as to form the amphiphilic polymer,

wherein R, m, and n are as defined in formula (II).

Before step (b), the method further includes a step of activating the biodegradable polyester block using an activator in the presence of a solvent. Examples of the activator include N,N′-dicyclohexylcarbodiimide, N,N′-diisopropylcarbodiimide, 1-ethyl-3-(3-dimethylaminopropyl)carbodiimide hydrochloride, and combinations thereof. Examples of the solvent include dimethyl sulfoxide, dimethylformamide, and combinations thereof.

Moreover, in step (a), in addition to the compound of formula (VI), a compound having the following formula (VI′) and carrying positive charge might be produced.

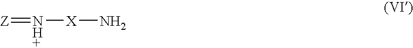

In formula (VI′), Z and X are as defined in formula (I). To enhance the productivity of the amphiphilic polymer, step (a) is preferably conducted in the presence of a reducing agent so as to reduce formula (VI′) to formula (VI). Alternatively, formula (VI′) can be reduced to formula (VI) under hydrogen atmosphere by high-pressure hydrogenation reaction.

Preferably, the sugar of formula (III) or (IV) has a molecular weight ranging from 180 to 20,000, more preferably from 300 to 10,000, and most preferably from 300 to 7,000. Examples of the sugars include D-glucose, D-mannose, D-galactose, D-talose, D-gulose, D-idose, D-allose, D-altrose, L-idose, L-gulose, L-glucose, D-ribose, D-arabinose, D-xylose, D-iyxose, L-fucose, L-rhamnose, L-fucose, D-rhamnose, cellobiose, maltose, lactose, glucan, galactobiose, maltotriose, maltotetraose, panose, gentiobiose, isomaltose, melibiose, etc.

Preferably, the biodegradable polyester block is derived from poly(lactic acid), poly(glycolic acid), poly(hydroxy butyrate), polycaprolactone, and poly(hydroxy valerate). More preferably, the biodegradable polyester block is derived from poly(lactic acid) and polycaprolactone.

Preferably, the biodegradable polyester block has a molecular weight ranging from 500 to 25,000, more preferably from 500 to 13,000, and most preferably from 1000 to 10,000.

### EXAMPLES

### Preparation of Amphiphilic Polymer

### Example 1

102.6 g Lactose (Mw. 342) and 18 g ethylenediamine were respectively dissolved in 300 ml and 10 ml of de-ionized water at ambient temperature so as to form a lactose solution and an ethylenediamine solution, respectively. The lactose solution was added dropwise into the ethylenediamine solution, followed by stirring for 4 hours, so as to form a reaction solution having a compound of formula (p3) and a compound of formula (p3′).

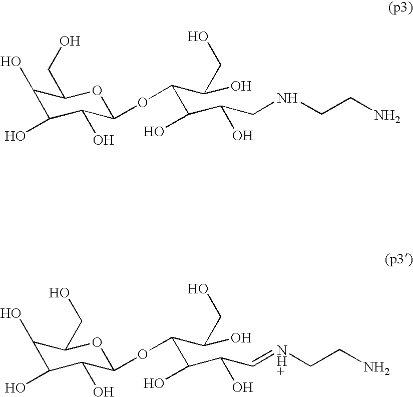

In an ice bath, the reaction solution was added with 12.5 g sodium borohydride, and was stirred for 1 day, such that the compound of formula (p3′) in the reaction solution was reduced to the compound of formula (p3). After water was removed from the reaction solution, the compound of formula (p3) was purified using an acetone/methanol solution. The purified compound (p3) was identified using nuclear magnetic resonance spectroscopy (NMR, ADVANCED 300, commercially available from BRUKER). ¹H (300 MHz, D₂O): δ4.38 (d, J=7.0 Hz, H1 of galactose), 4.19˜4.04 (m, 1H, sugar), 3.89˜3.83 (m, 1H, sugar), 3.77˜3.52 (m, 9H, sugar), 3.48˜3.33 (m, 1H, sugar), 3.19˜3.03 (m, 4H, CH₂N), 2.98˜2.83 (m, 2H, CH₂N).

Poly(lactic acid) having an average molecular weight of 3200 was dissolved in dimethyl sulfoxide, followed by activation using N,N′-dicyclohexylcarbodiimide (an activator) for 4 hours. The aforesaid purified compound (p3) was reacted with the activated poly(lactic acid) for 4 to 8 hours, followed by a purification step using a dialysis membrane, so as to form a polymer. The polymer thus formed was identified using NMR, Fourier Transform Infrared (FT-IR), and transmission electron microscopy (TEM).

The result determined by NMR is as follows:

1H (300 MHz, D⁶-DMSO): δ5.55 (d, J=5.8 Hz, 1H, H1 of lactose), 5.17 (Quartet, J=5.3 Hz, CH of PLA), 3.8˜2.7 (m, 18H, sugar, NCH₂—CH₂N), 1.6 (d, J=5.3 Hz, CH₃ of PLA).

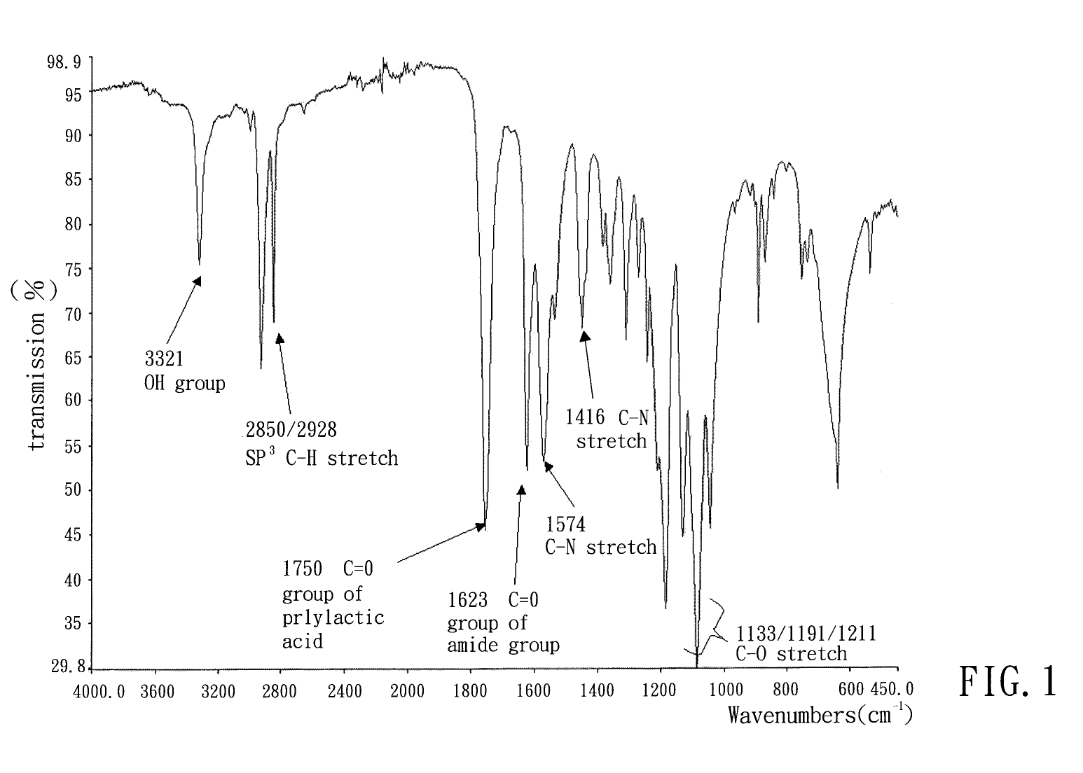

The results determined by FT-IR (see FIG. 1) and NMR indicate the polymer to be an amphiphilic polymer having the following formula (A):

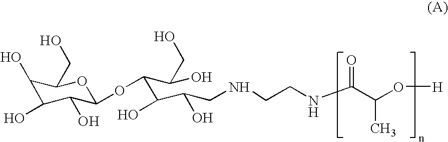

in which n is an integer ranging from 30 to 50.

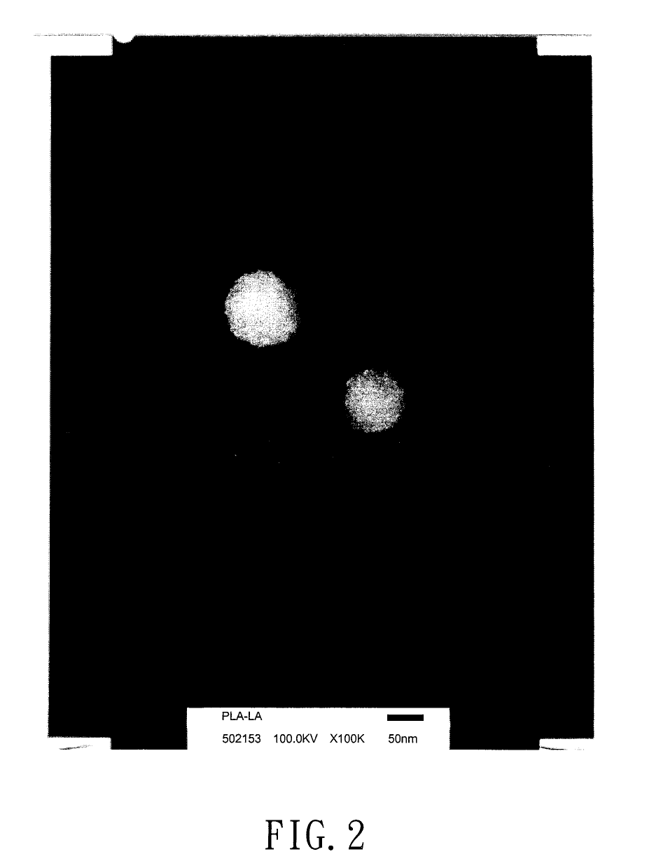

For TEM observation, a colloid solution prepared by dispensing the amphiphilic polymer of formula (A) in water was deposited on a copper grid, followed by a negative staining procedure using 20 μl of 2% potassium phosphotungstate for 5 to 10 minutes. The result shown in FIG. 2 indicates formation of micelles of the amphiphilic polymer according to this invention.

### Example 2

The method for preparing an amphiphilic polymer in this example was similar to that of the previous example except that the poly(lactic acid) in Example 2 has an average molecular weight of 5600.

### Example 3

50 g Glucan (Mw. 15000-20000) and 2 g ethylenediamine were respectively dissolved in 300 ml and 10 ml of de-ionized water so as to form a glucan solution and an ethylenediamine solution, respectively. The glucan solution was added dropwise into the ethylenediamine solution, followed by stirring for 4 hours, so as to form a reaction solution. In an ice bath, the reaction solution was added with 1.2 g sodium borohydride, and was stirred for 1 day. The desired compound was obtained after purification.

Polycaprolactone having an average molecular weight of 17,000 was dissolved in dimethyl sulfoxide, followed by activation using N,N′-dicyclohexylcarbodiimide (an activator) for 9 hours. The aforesaid purified compound was reacted with the activated polycaprolactone for 4 to 8 hours, followed by a purification step using dichloromethane and methanol, so as to form an amphiphilic polymer having formula (B):

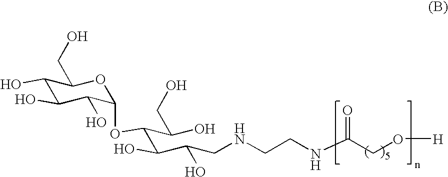

in which n is an integer ranging from 130 to 150.

### Test Methods

To determine the penetration ability of the amphiphilic polymers thus obtained, micelles composed of the amphiphilic polymers of the invention and encapsulating a desired substance to be delivered into skin were prepared (see Experiments). The micelles thus obtained were subjected to loading content and skin penetration tests. Loading content refers to the percentage of weight of the desired substance based on the total weight of the micelles. The skin penetration test was carried out according to the disclosure in Journal of Pharmaceutical and Biomedical Analysis, 40 (2006): 1187-1197. In this invention, partial thickness skin (including epidermis and partial dermis) of pigs and Franz diffusion cell with 0.785 cm² penetration area were used, and the test was conducted at 37±0.2° C. for 24 hrs.

### Preparation of Micelles

### Experiment 1

Into a 0.1 wt % amphiphilic polymer suspension prepared by dispensing the amphiphilic polymer of Example 1 in deionized water, ellagic acid dissolved in ethanol was slowly added so as to form a mixture solution, in which the weight ratio of ellagic acid to the amphiphilic polymer is 1:9. The mixture solution was subjected to ultra-sonication for 15 minutes, followed by a dialysis procedure, so that micelles encapsulating ellagic acid were gradually formed. The micelles were dried using a freeze dryer, followed by determination of the loading content thereof. For the skin penetration test, a test solution having 1.2 mg/ml micelle concentration was prepared by dissolving the micelles in deionized water. The loading content and the skin penetration rate of the micelles of Experiment 1 are shown in Tables 1 and 2, respectively.

### Experiment 2

The micelles prepared in Experiment 2 were similar to those of Experiment 1 except that the amphiphilic polymer used in Experiment 2 was prepared using the method of Example 2. The loading content and the skin penetration rate of the micelles are shown in Tables 1 and 2.

### Experiment 3

The micelles prepared in Experiment 3 were similar to those of Experiment 1 except that the amphiphilic polymer used in this Experiment was prepared using the method of Example 3. The loading content and the skin penetration rate of the micelles are shown in Tables 1 and 2.

### Experiment 4

Into a 0.1 wt % amphiphilic polymer suspension prepared by dispensing the amphiphilic polymer of Example 1 in acetone, arbutin dissolved in deionized water was slowly added so as to form a mixture solution, in which the weight ratio of arbutin to the amphiphilic polymer is 1:20. The mixture solution was mixed using a homogenizer at 10,000 rpm for 5 minutes, and was subsequently evaporated to remove acetone, thereby forming arbutin-encapsulating micelles. The loading content of the micelles thus formed is shown in Table 1.

### Comparative Experiment 1: Preparation of Micelles

The micelles prepared in Comparative Experiment 1 were similar to those of Experiment 1 except that the amphiphilic polymer used here was a conventional amphiphilic polymer made from poly(lactic acid) having a molecular weight of 4200 and polyethylene glycol. The loading content and the skin penetration rate are shown in Tables 1 and 2.

Comparative Experiment 2: Preparation of an Ellagic acid Solution

An ellagic acid solution was prepared by diluting 72 μl of 1 mg/ml ellagic acid solution (dissolved in ethanol) with deionized water to a total volume of 1 ml. The skin penetration rate is shown in Table 2.

TABLE 1

| | Experiment | | | Comparative |
|---|---|---|---|---|
| | 1 | Experiment 2 | Experiment 3 | Experiment 1 |
| loading | 6.23 | 6.29 | 3.81 | 3.75 |
| content | | | | |
| (wt %) | | | | |

TABLE 2

| | | | | Comparative |
|---|---|---|---|---|
| | Experiment | Experiment | Comparative | Experiment |
| | 1 | 3 | Experiment 1 | 2 |
| Skin | 12.17 | 10.36 | 11.50 | 8.83 |
| penetration | | | | |
| rate (%) | | | | |

Note that, in Table 1, the micelles of Experiments 1 to 3 exhibit superior loading content over that of Comparative Experiment 1. In addition, in Table 2, compared with the ellagic acid solution of Comparative Experiment 2, the micelles composed of the amphiphilic polymer of this invention and encapsulating ellagic acid exhibits superior skin penetration rate, about 37.8% ((12.17−8.83)/8.83) improvement for Experiment 1. Moreover, the micelles of Experiment 1 exhibit higher skin penetration rate than those of the Comparative Experiment 1, which were formed from the conventional amphiphilic polymer.

It should be noted, although ellagic acid and arbutin are used as an encapsulated substance in the embodiments of this invention, any suitable substance, e.g., cosmetics, drug, or food, may be used. Examples of such substance include CoQ10, vitamins (e.g., vitamins A, C, and E), amphotericin B, paclitaxol, adriamycin, etc.

With this invention, a novel amphiphilic polymer is provided as a carrier, which can efficiently encapsulate a desired substance and deliver the substance into skin. In addition, in the method for preparing the amphiphilic polymer according to this invention, since the diamine compound is used to connect the biodegradable polyester block and the sugar, the protection and deprotection steps required in the prior art can be eliminated, thereby simplifying the preparation procedure and lowering manufacturing costs.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An amphiphilic polymer having the following formula (I): 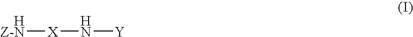
wherein Z is a hydroxyl-substituted aliphatic group having formula (Z1) or (Z2): 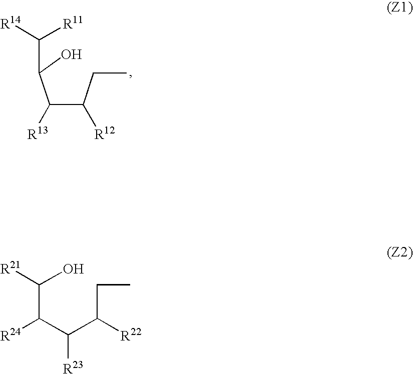
wherein R¹¹ and R²¹ are independently hydrogen, hydroxyl, hydroxymethyl, methyl, or a C₁-C₂₀ alkyl group, and R¹², R¹³, R¹⁴, R²², R²³, and R²⁴ are independently hydrogen, hydroxyl, or a sugar moiety;
X is a C₁-C₆ divalent aliphatic group; and
Y is a biodegradable polyester block having a repeating unit represented by the following formula (II): 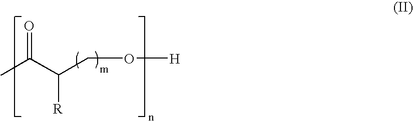
wherein, in each repeating unit, R is hydrogen or a C₁-C₁₈ alkyl group, m is an integer ranging from 0 to 5, and n is an integer ranging from 10 to 300.

2. The amphiphilic polymer of claim 1, wherein R¹², R¹³, R¹⁴, R²², R²³, and R²⁴ are independently hydrogen.

3. The amphiphilic polymer of claim 2, wherein R¹¹ and R²¹ are independently a hydroxymethyl, hydrogen, or methyl group.

4. The amphiphilic polymer of claim 3, wherein Z is a hydroxyl-substituted aliphatic group having the formula (Z2), and, in formula (Z2), R²¹ is a hydroxymethyl group; R²² and R²³ are independently a hydroxyl group; and R²⁴ is 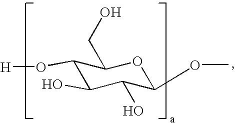
wherein a is an integer ranging from 1 to 9.

5. The amphiphilic polymer of claim 1, wherein Z is a hydroxyl-substituted aliphatic group having the formula (Z2), and, in formula (Z2), R²¹ is 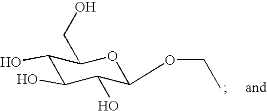
R²², R²³, and R²⁴ are independently a hydroxyl group.

6. The amphiphilic polymer of claim 1, wherein X is a C₁-C₆ alkylene group.

7. The amphiphilic polymer of claim 1, wherein said biodegradable polyester block is derived from one selected from the group consisting of poly(lactic acid), poly(glycolic acid), poly(hydroxy butyrate), polycaprolactone, and poly(hydroxy valerate).

8. The amphiphilic polymer of claim 1, wherein said biodegradable polyester block is derived from one selected from the group consisting of poly(lactic acid) and polycaprolactone.

9. The amphiphilic polymer of claim 1, wherein R of formula (II) is a methyl group or a hydrogen group, and m is an integer ranging from 0 to 4.

10. A method for preparing an amphiphilic polymer of claim 1, comprising the following steps:
(a) reacting a diamine compound of formula (V):
H₂N—X—NH₂ (V)
with a sugar having formula (III) or (IV): 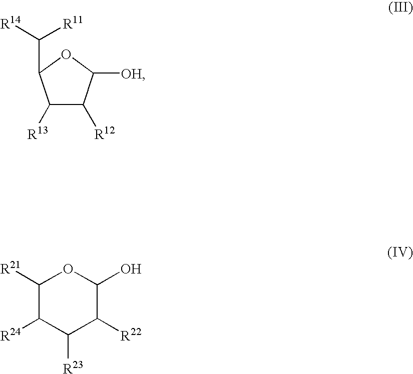
so as to form a compound having formula (VI), 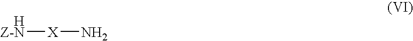
wherein Z is a hydroxyl-substituted aliphatic group having formula (Z1) or (Z2): 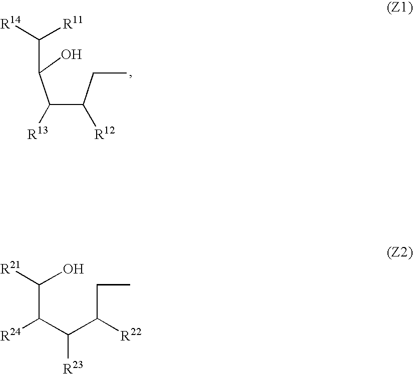
wherein R¹¹ of formulae (III) and (Z1) and R²¹ of formulae (IV) and (Z2) are independently hydrogen, hydroxyl, hydroxymethyl, methyl, or a C₁-C₂₀ alkyl group, and R¹², R¹³, R¹⁴ of formulae (III) and (Z1) and R²², R²³, and R²⁴ of formulae (IV) and (Z2) are independently hydrogen, hydroxyl, or a sugar moiety; and
(b) reacting a biodegradable polyester block of formula (VII): 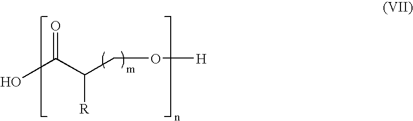
with the compound having formula (VI) so as to form the amphiphilic polymer,
wherein, R is hydrogen or a C₁-C₁₈ alkyl group, m is an integer ranging from 0 to 5, and n is an integer ranging from 10 to 300.

11. The method of claim 10, wherein the step (a) is conducted in the presence of a reducing agent, the reducing agent being selected from the group consisting of sodium borohydride, sodiumcyanoborohydride, and the combination thereof.

12. The method of claim 10, further comprising, before step (b), a step of activating the biodegradable polyester block using an activator in the presence of a solvent, the activator being selected from the group consisting of N,N′-dicyclohexylcarbodiimide, N,N′-diisopropylcarbodiimide, 1-ethyl-3-(3-dimethylaminopropyl)carbodiimide hydrochloride, and combinations thereof, the solvent being selected from the group consisting of dimethyl sulfoxide, dimethylformamide, and combinations thereof.

13. The method of claim 10, wherein the sugar of formula (III) or (IV) has a molecular weight ranging from 180 to 20,000.

14. The method of claim 10, wherein the biodegradable polyester block of formula (VII) has a molecular weight ranging from 500 to 25,000.
